(19) United States
(12) Patent Application Publication
(10) Pub. No.: US 2022/0391647 A1
(43) Pub. Date: Dec. 8, 2022

(54) APPLICATION-SPECIFIC OPTICAL CHARACTER RECOGNITION CUSTOMIZATION

(71) Applicant: Microsoft Technology Licensing, LLC, Redmond, WA (US)

(72) Inventors: Baoguang SHI, Redmond, WA (US); Dinei Afonso Ferreira FLORENCIO, Redmond, WA (US)

(73) Assignee: Microsoft Technology Licensing, LLC, Redmond, WA (US)

(21) Appl. No.: 17/338,134

(22) Filed: Jun. 3, 2021

(51) Int. Cl. G06K 9/68; G06K 9/00; G06F 40/103; G06F 40/177

(52) U.S. Cl. CPC G06K 9/6814; G06K 9/00973; G06K 9/00456; G06F 40/103; G06F 40/177; G06K 2209/01

(57) ABSTRACT

A method for customizing an optical character recognition system is disclosed. The optical character recognition system includes a general-purpose decoder configured to convert character images, recognized in a digital image, into text based on a general-purpose text structure. An application-specific customization is received. The application-specific customization includes an application-specific text structure that differs from the general-purpose text structure. A customized model is generated based on the application-specific customization. An enhanced application-specific decoder is generated by modifying the general-purpose decoder to, during run-time execution of the optical character recognition system, leverage the customized model to convert character images demonstrating the application-specific text structure into text.

### BACKGROUND

Optical character recognition (OCR) is the process of converting digital images of typed, handwritten, or printed text into machine-encoded text. Non-limiting examples of such digital images may include a scanned document, a photo of a document, a scene-photo (e.g., a photo including text in a scene, such as on signs and billboards), and a still-frame of a video including characters/words (e.g., on signs or as subtitles). OCR systems may be used in a wide variety of applications. In some examples, an OCR system may be used for data entry from printed paper data records, such as passport documents, invoices, bank statements, computerized receipts, business cards, mail, printouts of static-data, or any suitable documentation. In some examples, an OCR system may be used for digitizing printed text so that such text they can be electronically edited, searched, stored more compactly, displayed online, and/or used in machine processes, such as cognitive computing, machine translation, (extracted) text-to-speech, key data, and text mining.

### SUMMARY

A method for customizing an optical character recognition (OCR) system is disclosed. The optical character recognition system includes a general-purpose decoder configured to convert character images, recognized in a digital image, into text based on a general-purpose text structure. An application-specific customization is received. The application-specific customization includes an application-specific text structure that differs from the general-purpose text structure. A customized model is generated based on the application-specific customization. An enhanced application-specific decoder is generated by modifying the general-purpose decoder to, during run-time execution of the OCR system, leverage the customized model to convert character images demonstrating the application-specific text structure into text.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an optical character recognition (OCR) customization computing system configured to customize an OCR system for application-specific operation.

FIG. 2 shows an example grammar weighted finite state transducer (WFST).

FIG. 3 shows an example lexicon WFST.

FIG. 4 show an example optimized WFST that is a composition of the grammar WFST shown in FIG. 2 and the lexicon WFST shown in FIG. 3.

FIG. 5 shows an example optimized WFST labeled with customized non-terminal symbols corresponding to an application-specific customized WFST.

FIG. 6 shows an example application-specific customized WFST.

FIG. 7 shows the optimized WFST of FIG. 5 with the customized non-terminal symbols replaced by the application-specific customized WFST shown in FIG. 6.

FIG. 8 shows an example digital image of a driver license including different fields having different application-specific structured text.

FIGS. 9A and 9B show an example comparison of results between a default OCR system and a customized OCR system.

FIG. 10 shows an example method for customizing an OCR system.

FIG. 11 shows an example computing system.

### DETAILED DESCRIPTION

An optical character recognition (OCR) system is configured to convert digital images of text. For example, a digital image including a plurality of pixels each having one or more values (e.g., grayscale value and or RGB values) may be converted into machine-encoded text (e.g., a string data structure). A typical OCR system is designed for general purpose use in order to provide relatively accurate character recognition for a wide variety of different forms of text (e.g., different fonts, languages, vocabularies) that conform to a general-purpose text structure. As used herein, the term “text structure” may include one or more of a character set, vocabulary, and/or format of an expression that an OCR system is configured to recognize.

However, because the OCR system is designed for general purpose use, there are scenarios where the OCR system struggles to accurately recognize particular forms of text that differ from the general-purpose text structure for which the OCR system is originally configured. Non-limiting examples include dates, currencies, phone numbers, addresses, and other text that include digits and symbols that are hard to distinguish. As one example, a general-purpose OCR system may struggle to accurately distinguish “1” (one), “l” (lower-case L), “!” (exclamation mark), and “|” (pipe).

Increasing recognition accuracy of structured text by an OCR system can be seen as a case of domain or application-specific adaptation. One strategy for domain or application-specific adaption is to finetune recognition models with domain-specific or application-specific data. However, finetuning requires collecting a sufficiently large dataset in the same domain or related to the same application. Therefore, finetuning can be very expensive and impractical in many cases due to the sensitivity of the data in the target domain or target application.

To address the above and other issues, the present description is directed to a method for customizing an OCR system for application-specific use in a resource-efficient manner. In one example, the OCR system is customized based on an application-specific customization. The application-specific customization includes an application-specific text structure that differs from a general-purpose text structure used by a general-purpose decoder of the OCR system. A customized model is generated based on the application-specific customization. The customized model is biased to favor the application-specific text structure over the general purpose-text structure when recognizing text that demonstrates the application-specific text structure. An enhanced application-specific decoder is generated by modifying the general-purpose decoder to, during run-time execution of the OCR system, leverage the customized model to convert character images demonstrating the application-specific text structure into text. The optical character recognition system is configured to use the enhanced application-specific decoder to convert character images recognized in the digital image into text.

By customizing the OCR system in this manner, the customized OCR system is configured to recognize text that matches the application-specific text structure with significantly improved accuracy relative to the general-purpose decoder that uses the general-purpose text structure. Moreover, such customization minimally impacts the accuracy of the OCR system's ability to recognize other text that does not match the application-specific text structure. Such a customization method requires no fine-tuning of recognition models with domain-specific or application-specific data and therefore is favorable when collecting such data is expensive or infeasible due to privacy. Further, in some examples, an OCR system may be customized based on multiple different customizations that can be used for different domains/application-specific scenarios, such that different customized models can be applied to different samples of text that demonstrate different structured text associated with the different customizations.

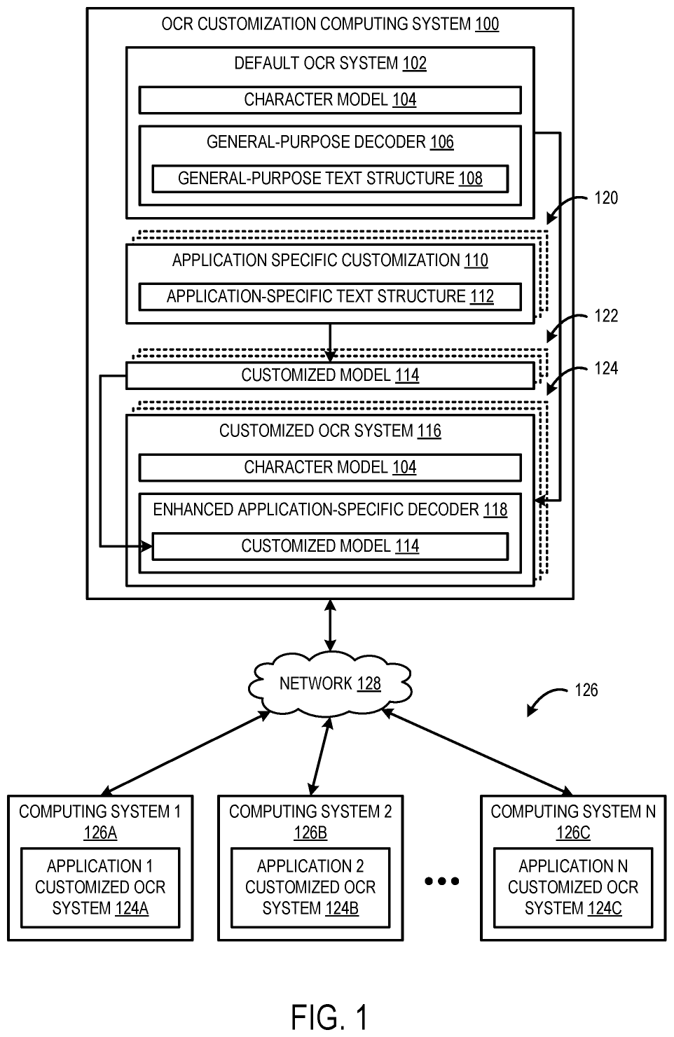

FIG. 1 shows an optical character recognition (OCR) customization computing system 100 configured to customize an OCR system 102 for application-specific operation. The OCR system 102 includes a character model 104 and a general-purpose decoder 106.

The character model 104 is configured to recognize character images in a digital image that is provided as input to the OCR system 102. The character model 104 may include any suitable type of model including, but not limited to, a Convolutional Neural Network (CNN), a Long Short-Term Memory (LSTM), Hidden Markov Model (HMM), and a Weighted Finite State Transducer (WFST). In one example, the character recognition model is based on a Convolutional Neural Network (CNN)-Long Short-Term Memory (LSTM)-Connectionist Temporal Classification (CTC) framework.

The general-purpose decoder 106 is configured to convert character images, recognized in a digital image, into text based on a general-purpose text structure 108 (e.g., via machine learning training using training data exhibiting the general-purpose text structure and/or based on heuristics corresponding to the general-purpose text structure). The general-purpose decoder 106 may employ any suitable type of model to perform such conversion operations. In some examples, the general-purpose decoder 106 may include a neural network, such as a CNN or an LSTM. In other examples, the general-purpose decoder 106 may include a WFST for decoding the output sequences of the character model 104.

A WFST is a finite-state machine whose state transitions are labeled with input symbols, output symbols, and weights. A state transition consumes the input symbol, writes the output symbol, and accumulates the weight. A special symbol ε means consuming no input when used as an input label or outputting nothing when used as an output label. Therefore, a path through the WFST maps an input string to an output string with a total weight.

A set of operations are available for WFSTs. Composition (∘) combines two WFSTs: Denoting the two WFSTs by T₁ and T₂, if the output space (symbol table) of T₁ matches the input space of T₂, the two WFSTs can be combined by the composition algorithm, as in T=T₁∘T₂. Applying T on any sequence is equivalent to applying T₁ first, then T₂. Determinization and minimization are two other WFST optimization operations. Determinization makes each WFST state have at most one transition with any given input label and eliminates all input ε-labels. Minimization reduces the number of states and transitions. In one example, a WFST is optimized by combining the two operations, as in T₀=optim(T)=minimize(determinize(T)) and yields an equivalent WFST that is faster to decode and smaller in size.

In one example, the general-purpose decoder 106 includes a WFST composed and optimized from a plurality of WFSTs including a grammar WFST, a lexicon WFST, and a blank and repetition removal WFST.

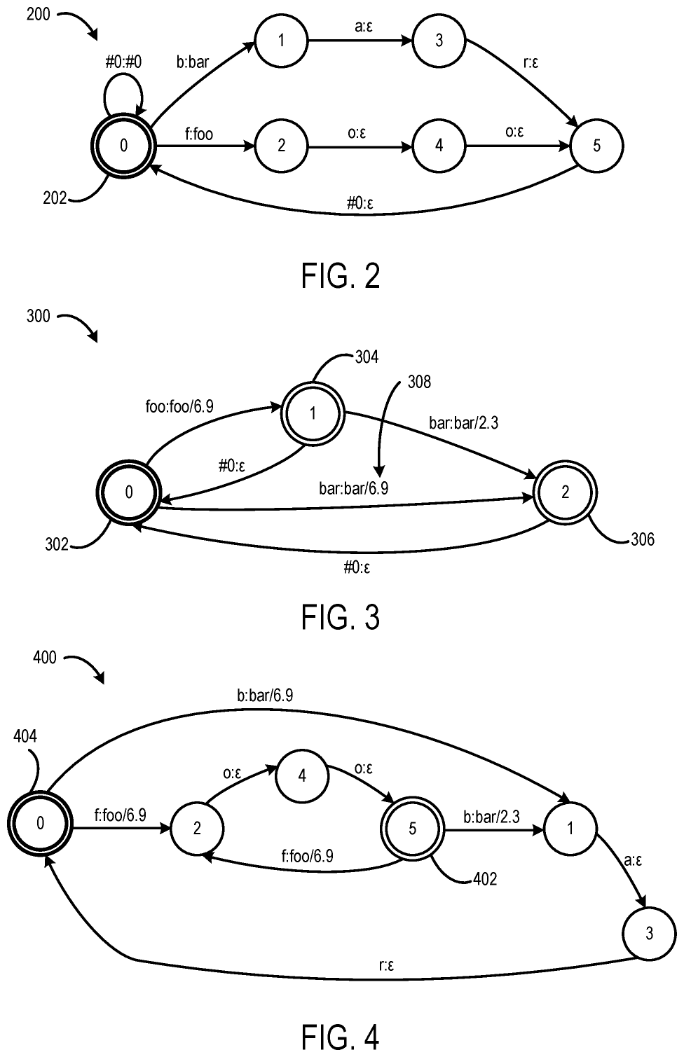

FIG. 2 shows an example grammar WFST 200 in simplified form. The grammar WFST 200 represents a grammar model for the words “foo” and “bar.” The grammar WFST 200 includes a plurality of states represented by circles. The thick double circle 202 indicates a final state. The states are connected by transitions. The transitions are labeled using the format: “<input label>:<output label>/<weight>”, or “<input label>:<output label>” when the weight is zero. The auxiliary symbol “#0” is for disambiguation.

The grammar WFST 200 models n-gram probabilities of predicted words. The input and output symbols of the WFST 200 are predicted words (or sub-word units), and the transition weights represent n-gram probabilities of the predicted words.

FIG. 3 shows an example lexicon WFST 300 in simplified form. The lexicon WFST 300 represents a lexicon or spelling model for the words “foo” and “bar.” The lexicon WFST 300 includes a plurality of states represented by circles. The thick double circle 302 indicates both a start and a final state of the lexicon WFST 300. The thin double circles 304 and 306 indicate final states where the decoding can end. The states are connected by transitions. The transitions are labeled using the format: “<input label>:<output label>/<weight>”, or “<input label>:<output label>” when the weight is zero. The auxiliary symbol “#0” is for disambiguation, when a word has more than one spelling (e.g., spelling in lower-case and upper-case letters), for example. In the illustrated example, at 308, the weight value (6.9) is calculated from log(0.001), meaning unigram probabilities 0.001 for words “foo” and “bar”. The transition from state 1 to 2 means a 0.01 bigram probability for the words “foo bar”.

The lexicon WFST 300 models the spelling of every word in the grammar WFST 200. The input space of the lexicon WFST 300 is the set of characters supported by the default OCR system 102 and the output space is the words modeled by the grammar WFST 200.

FIG. 4 shows an optimized WFST 400 composed of the grammar WFST 200 and the lexicon WFST 300. The optimized WFST 400 includes a plurality of states represented by circles. The thin double circle 402 indicates a starting state. The thick double circle 404 indicates a final state. The states are connected by transitions. The transitions are labeled using the format: “<input label>:<output label>/<weight>”, or “<input label>:<output label>” when the weight is zero. The optimized WFST 400 may be represented by the equation:

T=optim(L∘G)

where L represents the WFST 300, and the G represents the WFST 200. A CTC-based OCR system may be configured to output extra blank symbols. Thus, an extra WFST C is left-composed with T to perform a “collapsing rule” of the CTC-based OCR system. In practice, C is realized by inserting states and transitions that consume all blanks and repeated characters to L∘G. The resulting WFST may be represented by the equation:

T_{ctc}=optim(C∘T)

The WFSTs 200, 300, 400 shown in FIGS. 2-4 are provided as simplified non-limiting examples. In actual implementations, the WFSTs may be substantially more complex to accommodate large-scale grammar and lexicon datasets.

Returning to FIG. 1, the general-purpose text structure 108 used by the general-purpose decoder 106 may include a large-scale dataset that is broadly applicable to allow for the general-purpose decoder 106 to recognize a wide variety of different types of character images and convert such character images to text. The general-purpose text structure 108 may include a large-scale lexicon such as a dictionary. In some examples, the general-purpose text structure 108 may include lexicons in different languages. In some examples, the general-purpose text structure 108 may include one or more grammar rule sets corresponding to the different languages. The general-purpose text structure 108 may further specify different formats of text. For example, the general-purpose text structure 108 may specify the format of a word, a phrase, and/or a sentence that also may be referred to as grammar rules. The objective of the general-purpose text structure 108 is to allow the general-purpose decoder 106 to convert a wide variety of character images to text with a baseline level of precision that applies across a range of different character images. As such, the OCR system 102 may be referred to as a “default” OCR system that is configured for general purpose use across a wide variety of different applications. Since the general-purpose decoder 106 is configured to recognize a wide variety of different types of character images across different applications, the general-purpose decoder 106 may have reduced recognition accuracy in some application-specific scenarios where text has a structure that differs from the general-purpose text structure.

Accordingly, the OCR customization computing system 100 is configured to customize the default OCR system 102 to generate a customized OCR system 116 that is configured for application-specific operation. In particular, the customized OCR system 116 may be configured to convert character images demonstrating an application-specific text structure 112 into text with increased recognition accuracy relative to the default OCR system 102.

The OCR customization computing system 100 is configured to receive or generate an application-specific customization 110. The application-specific customization 110 dictates the manner in which the default OCR system 102 is modified for a specific application. The application-specific customization 110 may be received from any suitable source. In some examples, the application-specific customization 110 may be received from a software developer that desires to customize the default OCR system 102 for a specific application. In other examples, the application-specific customization 110 may be received from a user that desires to customize the default OCR system 102 for the user's personal preferences or personal information.

The application-specific customization 110 includes an application-specific text structure 112 that differs from the general-purpose text structure 108 that is used by the general-purpose decoder 106 of the default OCR system 102. The application-specific text structure 112 may differ from the general-purpose text structure 108 in any suitable manner. In some examples, the application-specific text structure 112 may include a customized vocabulary. In an example where the OCR system 102 is customized for a pharmaceutical application, the application-specific text structure 112 may include a list of medications. Such medications may be absent from a typical dictionary that would be used by the general-purpose decoder 106.

In some examples, the application-specific text structure 112 may include a designated format for an expression, which may be referred to in some cases as a “regular expression” or a “regex.” The knowledge of the designated format may substantially improve the recognition of structured text, as the designated format may dictate that candidate characters are limited by positions and contexts. In some examples, the designated format may specify that the expression includes a plurality of character positions, and one or more character positions of the plurality of character positions includes a number or a non-letter character. For example, an application-specific text structure for a California car license plate number follows the format one number digit, followed by three capital letters, then followed by three number digits.

In some examples, the designated format specifies that the structured text includes specified columns and/or rows in a table. Returning to the pharmaceutical example, specific rows and/or columns in an invoice or inventory tracking document may be labeled as medications, and a customized OCR system may process such rows and/or columns using a medication vocabulary list instead of a general-purpose dictionary. Further, other rows and/or columns may be processed using the general-purpose dictionary.

In some examples, the designated format specifies that the structured text is located in a designated region of a digital image being processed by the OCR system. For example, in a digital image of a driver license, a license number may be positioned in a same location on every driver license for a particular jurisdiction (e.g., every California driver license). The application-specific text structure may specify that structured text positioned in a region on the driver license (e.g., the region where the license number is positioned) may be processed based on the application-specific text structure 112 instead of the general-purpose text structure 108.

The OCR customization computing system 100 is configured to generate a customized model 114 based on the application-specific text structure 112. The customized model 114 is biased to favor the application-specific text structure 112 over the general-purpose text structure 108 when recognizing text. The customized model 114 may take any suitable form. In one example, the customized model 114 includes a WFST. The application-specific text structure 112 may be used to specify search patterns for the WFST. To this end, the OCR customization computing system 100 is configured to translate the application-specific text structure 112 into a deterministic finite automaton (DFA). In one example, the OCR customization computing system 100 may be configured to use the Thompson's construction algorithm to perform such translation. In other examples, the OCR customization computing system 100 may be configured to use a different translation algorithm. Since a WFST is also a finite automaton, the DFA of the application-specific text structure 112 may be converted into a WFST by turning every transition label into a pair of identical input and output labels and assign a unit weight. In one example, the OCR customization computing system 100 is configured to use the open-source grammar compiler Thrax to compile application-specific text structure 112 directly to WFSTs.

Note that a WFST is one non-limiting example of a type of model that may be used to generate the customized model 114. In other implementations, the customized model 114 may include a different type of model.

The OCR customization computing system 100 is configured to customize the default OCR system 102 by modifying the general-purpose decoder 106 to generate a customized OCR system 116. The OCR customization computing system 100 is configured to modify the general-purpose decoder 106 to, during run-time execution, leverage the customized model 114 to convert character images demonstrating the application-specific text structure 112 into text. Modification of the general-purpose decoder 106 in this manner results in generation of an enhanced application-specific decoder 118.

Note that the enhanced application-specific decoder 118 is not formed anew from “whole cloth,” but instead is a modified version of the general-purpose decode 106 having enhanced features. In particular, the enhanced application-specific decoder 118 intelligently uses the customized model 114 to convert character images demonstrating the application-specific text structure 112 into text. Further, the enhanced application-specific decoder 118 is configured to convert character images demonstrating the general-purpose text structure 108 into text without using the customized model 114. The customized OCR system 116 is configured to use the enhanced application-specific decoder 118 to convert character images into text.

In one example, the customized model 114 is weighted relative to a corresponding default model of the general-purpose decoder 106 to bias the enhanced application-specific decoder 118 to use the customized model 114 instead of the default model to convert character images demonstrating the application-specific text structure 112 into text.

In implementations where the general-purpose decoder 106 includes one or more default WFSTs configured based on the general-purpose text structure 108, the OCR customization computing system 100 may be configured to modify the general-purpose decoder by adding a customized non-terminal symbol to the one or more default WFSTs to generate the enhanced application-specific decoder 118. The customized non-terminal symbol is configured to act as an entry and return point for a customized WFST that embodies the customized model 114. Accordingly, during runtime execution, the customized OCR system 116 is configured to, on-demand replace, the customized non-terminal symbol with the customized WFST, such that the customized WFST can convert character images demonstrating the application-specific text structure 112 into text.

The OCR customization computing system 100 may be configured to add any suitable number of instances of the customized non-terminal symbol to a default WFST for customization purposes. Each instance of the customized non-terminal symbol may be used to on-demand call the customized WFST during runtime execution.

The customized non-terminal symbol may take various forms that affect the conditions under which the customized WFST is called for converting character images into text. In some examples, the customized non-terminal symbol may include a unigram that can appear anywhere within a word or may stand alone as its own word. In this case, the customized WFST can be applied to part of a sentence corresponding to the unigram, while the rest of the sentence is scored by a default WFST. In other examples, the customized non-terminal symbol may include a sentence that is required to be matched exactly in order for the customized WFST to be called. In this case, the customized WFST can be applied to the entire sentence.

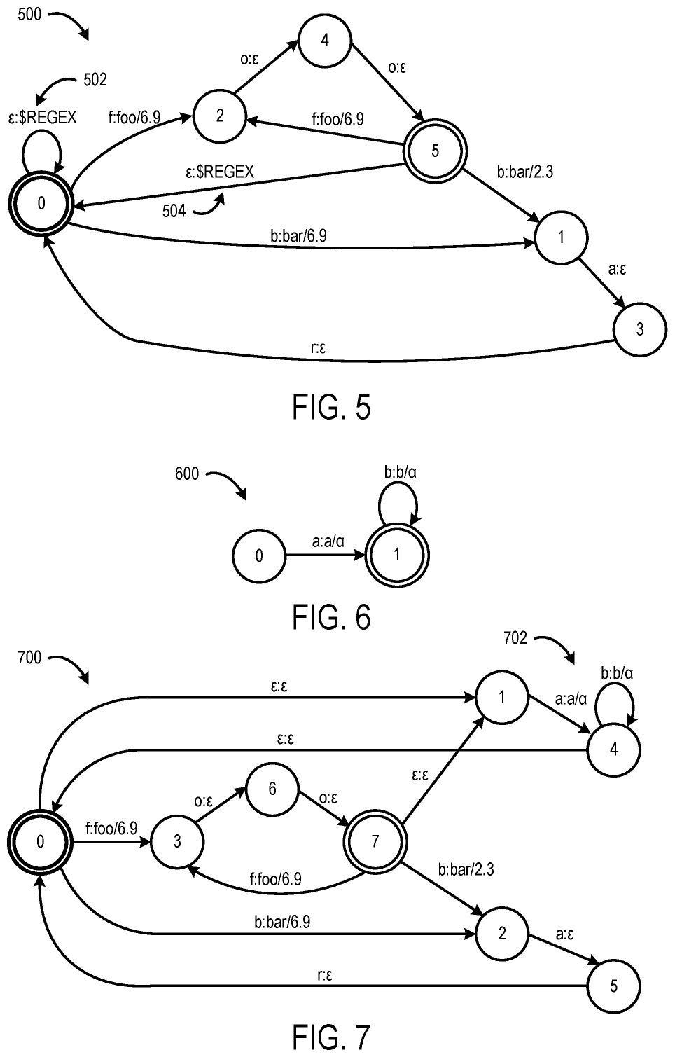

FIG. 5 shows an example WFST 500 that is labeled with customized non-terminal symbols. The WFST 500 is a modified/customized version of WFST 400 shown in FIG. 4. In the illustrated example, the customized non-terminal symbols are represented as “$REGEX”. A first $REGEX symbol 502 is labeled on a self-looping transition connected to the state zero (0) in the WFST 500. A second $REGEX symbol 504 is labeled on a transition going from state (5) to state zero (0) in the WFST 500. The WFST 500 may be denoted as Troot. The WFSTs 200 and 300 may be modified with $REGEX symbols to generate a modified grammar WFST (G′) and a modified lexicon WFST (L′). As such, Tᵣₒₒₜ=optim(G′∘L′).

FIG. 6 shows an example customized WFST 600. The customized WFST may be configured to have a small or even negative transition weight value so that paths through the customized WFST will be favored by the enhanced application-specific decoder 118. In one example, a length-linear function is used to assign weights in the WFST transitions. This may be implemented by left-composing a scoring WFST S with an unweighted customized WFST R to generate the customized WFST denoted as Tᵣ:

Tᵣ=S_{α}∘R

Here, Sα is a scoring WFST that has a single state that is both a start and final state and connects a number of self-loop transitions where the input and output labels are the supported symbols (characters). The weights of these transitions are set to a constant α. After the composition, the total weight of a path in Tᵣ for a matching text string will be nα, where n is the length of the string. In this way, the biasing strength of the customized WFST 600 in the enhanced application-specific decoder 118 can be adjusted. For example, lowering α increases the biasing strength and increasing α decreases the biasing strength. The OCR customization computing system 100 may be configured to set the biasing strength of the customized WFST to any suitable level to optimize performance of the enhanced application-specific decoder 118 to accurately convert character images into text.

The customized WFST 600 denoted as Tᵣ cannot be used directly for decoding since it only accepts text matching the custom non-terminal symbol (e.g., $REGEX). As such, the customized WFST 600 is combined with the modified WFST Tᵣₒₒₜ so that the decoder can output any text. Tᵣₒₒₜ and Tᵣ can be combined using a WFST replacement operation:

T′=replace(Tᵣₒₒₜ, Tᵣ) which replaces transitions labeled with $REGEX with the corresponding WFST Tᵣ.

FIG. 7 shows a modified WFST 700 after the $REGEX symbols are replaced with the customized WFST 600. The modified WFST 700 is denoted as T′. After replacement, state zero (0) and state 7 in T′ (corresponding to state 5 in Tᵣₒₒₜ) both have a transition to state 1, effectively acting as the entry and return points of the customized WFST Tᵣ shown at 702. After the replacement, T′ can be made into a CTC-compatible decoder to remove blank spaces in the same manner as discussed above with reference to the default WFST 400 shown in FIG. 4.

The WFSTs 500, 600, 700 shown in FIGS. 5-7 are provided as simplified non-limiting examples. In actual implementations, the WFSTs may be substantially more complex to accommodate large-scale grammar and lexicon datasets. Since these WFSTs may contain millions of states and transitions, the WFSTs may be costly to update or modify through fine tuning of different weights. By labeling transitions in the WFSTs with customized non-terminal symbols and performing dynamic replacement with customized WFSTS, the default WFST of the general-purpose decoder 106 may remain substantially fixed while only the customized WFST need be updated modified.

In some implementations, a WFST may be customized by adding a plurality of different non-terminal symbols that correspond to a plurality of different customized WFSTs that are generated using different forms of application-specific structured text. For example, different customized WFSTs may be generated using different custom vocabularies and/or different formats of expressions, and these different WFSTs may be associated with different transitions within the primary WFST of the decoder.

In some implementations, the customized OCR system 116 may be configured to generate a map of a digital image that specifies regions of the digital image where the customized model 114 is applied as dictated by the application-specific text structure 112. The map may further specify other regions where the general-purpose model of the general-purpose decoder 106 is applied. This concept may be extended to examples where an OCR is customized based on multiple customizations. In particular, the map may specify different regions where different customized models are applied based on the different application-specific structured text associated with the different customizations. The map may further specify other regions where the general-purpose model of the general-purpose decoder 106 is applied. In some examples, the customized OCR system 116 may refer to the map at runtime to select which model to apply to a given region in a digital image.

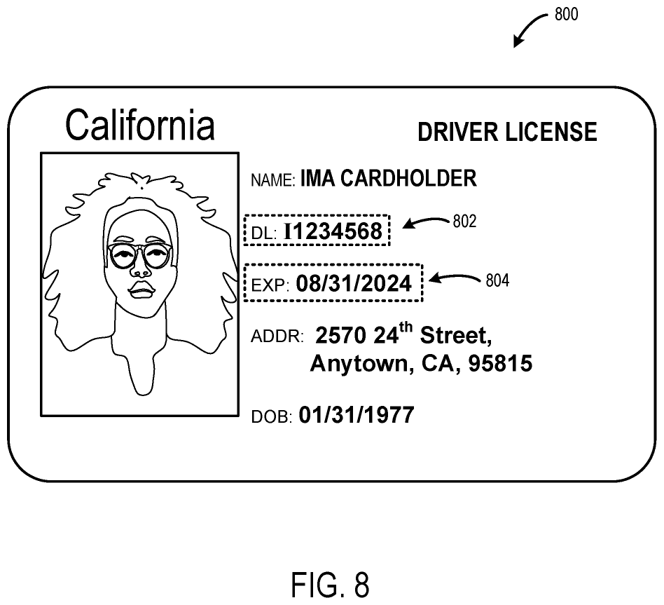

FIG. 8 shows an example digital image 800 of a driver license that includes a plurality of different fields having locations that are specified by different application-specific structured text corresponding to different customizations. For example, the different application-specific structured text may specify different pixel ranges (e.g., from pixel [222], [128] to pixel [298], [146]) that define the different fields in the digital image 800. Further, the different application application-specific structured text may specify different formats of text in the different fields. For example, a driver license identification (DIL) field 802 has a format that specifies one letter followed by seven number digits. In the illustrated example, the letter in the DIL field 802 is an “I.” The default OCR system 102 may misidentify the “I” as a “1,” because the default OCR system does not have the knowledge of the application-specific format that specifies that the first character is required to be a letter. On the other hand, the customized OCR system 116 may identify the DIL with greater accuracy relative to the default OCR system 102, because the customized OCR system 116 has knowledge of the application-specific structured text of the DIL field 802.

As another example, an expiration date field 804 has a format that specifies two number digits representing a day of the month, followed by two number digits representing a month of the year, followed by four number digits representing the year of expiration of the driver license. The customized OCR system 116 may identify the expiration date with greater accuracy relative to the default OCR system 102, because the customized OCR system 116 has knowledge of the application-specific structured text of the expiration date field 804. Namely, the customized OCR system 116 knows that the expiration date field 804 has a format that only includes number digits corresponding to specific numbers associated with a day, a month, and a year. The default OCR system 102 does not apply any of this knowledge when analyzing the character images in the expiration date field 804 and thus may provide less accurate results.

The digital image 800 of the driver license is provided as a non-limiting example in which different regions of a digital image may have different application-specific structured text that may be analyzed differently by a customized OCR system. An OCR system may be customized to apply different application-specific structured text to different regions of a digital image in any suitable manner.

Returning to FIG. 1, the OCR customization computing system 100 is configured to customize the default OCR system 102 differently for different applications. The OCR customization computing system 100 may be configured to receive a plurality of different application-specific customizations 120 for different applications. In some examples, the different application-specific customizations 120 may be received from different sources. For example, the different sources may include different software developers or different users. In other examples, the different application-specific customizations 120 may be received from the same source. For example, a software developer may desire to customize the default OCR system 102 for different uses within the same software application program.

Each of the plurality of different application-specific customizations 120 may include different application-specific text structures 112. In one example, each of the plurality of different application-specific customizations 120 include different application-specific vocabularies, different formats of expressions, and/or a combination thereof.

The OCR customization computing system 100 is configured to generate a plurality of different customized models 122 based on the different application-specific customizations 120. Further, the OCR customization computing system 100 is configured to generate a plurality of customized OCR system 124 by modifying the default OCR system 102 differently. In particular, each of the plurality of customized OCR system 124 is configured to leverage the specific customized model of the plurality of customized models 122 corresponding to the specific application for which the customized OCR system 124 is customized.

The OCR customization computing system 100 is configured to communicatively couple with a plurality of different computing systems 126 via a computer network 128. The plurality of computer systems 126 may be configured to receive differently customized OCR systems for use in different applications from the OCR customization computing system 100. In the illustrated example, a first computing system 126A receives a first customized OCR system 124A from the OCR customization computing system 100. The first customized OCR system 124A is customized for a first application. A second computing system 126B receives a second customized OCR system 124B from the OCR customization computing system 100. The second customized OCR system 124B is customized for a second application. The second customized OCR system 124B is customized differently than the first customized OCR system 124A. A third computing system 126C receives a third customized OCR system 124C from the OCR customization computing system 100. The third customized OCR system 124C is customized for a third application. The third customized OCR system 124C is customized differently than the first customized OCR system 124A and the second customized OCR system 124B.

When the plurality of application specific computing systems 126 execute the plurality of different customized OCR systems 124 to process the same digital image. Each of the plurality of different customized OCR systems 124 may output different text, because the different customized OCR systems 124 leverage different customized models 122 to convert character images, recognized in the digital image, into text.

The OCR customization computing system 100 is configured to customize the OCR system in an efficient manner that produces significantly improved recognition accuracy for character images demonstrating application-specific text structure relative to a general-purpose decoder. Further, such customization minimally impacts the accuracy of the OCR system's ability to recognize other text that does not match the application-specific text structure. Moreover, such customization requires no fine-tuning of recognition models with domain-specific or application-specific data and therefore is favorable when collecting such data is expensive or infeasible due to privacy.

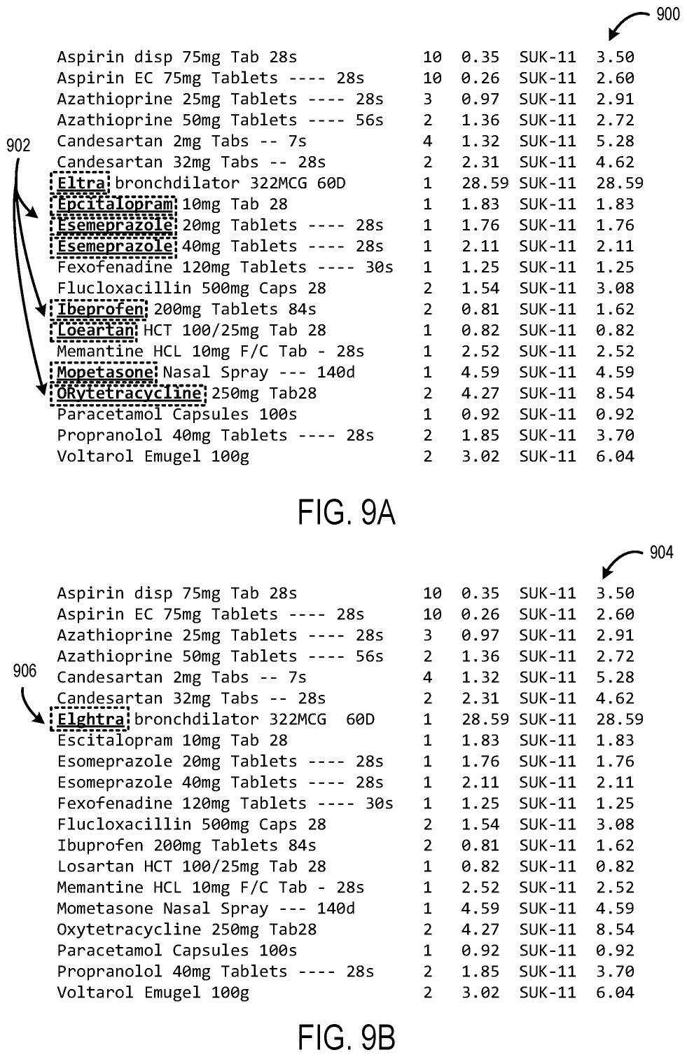

FIGS. 9A and 9B show an example comparison of OCR results between a default OCR system including a general-purpose decoder and a customized OCR system including an enhanced application-specific decoder. Both of the default OCR system and the customized OCR system scan a digital image of a pharmaceutical invoice including a list of medications. FIG. 9A shows a computer-readable text document 900 generated by the default OCR system based on scanning the pharmaceutical invoice. The results of the default OCR system include multiple conversion (e.g., spelling) errors indicated by the dashed boxes 902. FIG. 9B shows a computer-readable text document 904 generated by the customized OCR system based on scanning the pharmaceutical invoice. In this case, the customized OCR system includes a customized model that is generated based on a customized vocabulary including a list of medications. The results of the customized OCR system include a single conversion (e.g., spelling) error indicated by the dashed box 906. The customized OCR system provides increased recognition accuracy of the pharmaceutical invoice relative to the default OCR system, because the customized OCR system is configured to apply the customized model generated based on the application-specific customized vocabulary to convert the character images, recognized in the pharmaceutical invoice, to text.

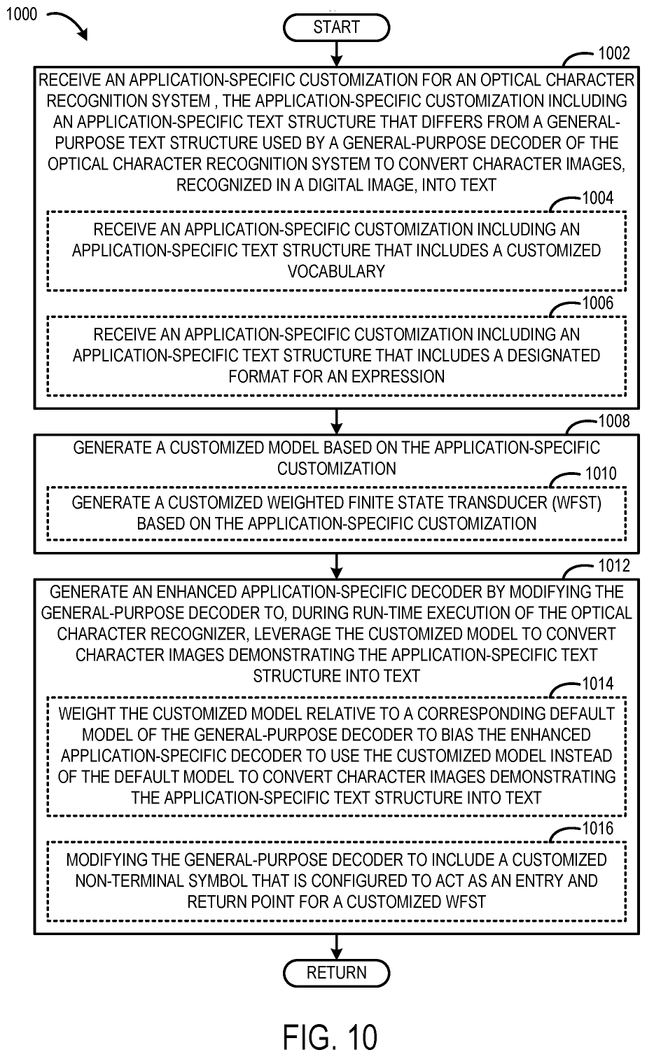

FIG. 10 shows an example method 1000 for customizing an optical character recognition system. For example, the method 1000 may be performed by the OCR customization computing system 100 shown in FIG. 1.

At 1002, the method 1000 includes receiving an application-specific customization for an OCR system. The application-specific customization includes an application-specific text structure that differs from a general-purpose text structure used by a general-purpose decoder of the OCR system to convert character images, recognized in a digital image, into text.

In some implementations, at 1004, the method 1000 optionally may include receiving an application-specific customization including an application-specific text structure that includes a customized vocabulary. The customized vocabulary may differ from a default vocabulary used by the general-purpose decoder.

In some implementations, at 1006, the method 1000 optionally may include receiving an application-specific customization including an application-specific text structure that includes a designated format for an expression. The designated format may differ from a default format used by the general-purpose decoder. In some examples, the designated format may specify a plurality of character positions of the expression, and one or more character positions of the plurality of character positions may include a number or a non-letter character. In some examples, the designated format may specify that the structured text includes specified columns and/or rows in a table. In some examples, the designated format may specify that the structured text is located in a designated region of the digital image.

At 1008, the method 1000 includes generating a customized model based on the application-specific customization.

In some implementations, the method 1000 optionally may include generating a customized WFST based on the application-specific customization.

At 1012, the method 1000 includes generating an enhanced application-specific decoder by modifying the general-purpose decoder to, during run-time execution of the optical character recognition system, leverage the customized model to convert character images demonstrating the application-specific text structure into text.

In some implementations, at 1014, the method 1000 optionally may include weighting the customized model relative to a corresponding default model of the general-purpose decoder to bias the enhanced application-specific decoder to use the customized model instead of the default model to convert character images demonstrating the application-specific text structure into text.

In some implementations, at 1016, the method 1000 optionally may include modifying the general-purpose decoder to include a customized non-terminal symbol that is configured to act as an entry and return point for a customized WFST. In this case, the enhanced application-specific decoder may correspond to the general-purpose decoder that is modified with the customized non-terminal symbols.

The customized OCR system may be configured to use the enhanced application-specific decoder to convert character images, recognized in the digital image, into text. By using the enhanced application-specific decoder, the customized model may be leveraged to convert character images demonstrating the application-specific text structure into text.

The above-described method enables customization of an OCR system in an efficient manner that significantly improves recognition accuracy of character images that demonstrate application-specific structured text relative to a general-purpose OCR system. Moreover, such customization minimally impacts the accuracy of the OCR system's ability to recognize other text that does not match the application-specific text structure. Such a customization method requires no fine-tuning of recognition models with domain-specific or application-specific data and therefore is favorable when collecting such data is expensive or infeasible due to privacy.

When user data is collected, users or other stakeholders may designate how the data is to be used and/or stored. Whenever user data is collected for any purpose, the user owning the data should be notified, and the user data should only be collected with the utmost respect for user privacy (e.g., user data may be collected only when the user owning the data provides affirmative consent, and/or the user owning the data may be notified whenever the user data is collected). If data is to be collected, it can and should be collected with the utmost respect for user privacy. If the data is to be released for access by anyone other than the user or used for any decision-making process, the user's consent will be collected before using and/or releasing the data. Users may opt-in and/or opt-out of data collection at any time. After data has been collected, users may issue a command to delete the data, and/or restrict access to the data. All potentially sensitive data optionally may be encrypted and/or, when feasible anonymized, to further protect user privacy.

In some implementations, the methods and processes described herein may be tied to a computing system of one or more computing devices. In particular, such methods and processes may be implemented as a computer-application program or service, an application-programming interface (API), a library, and/or other computer-program product.

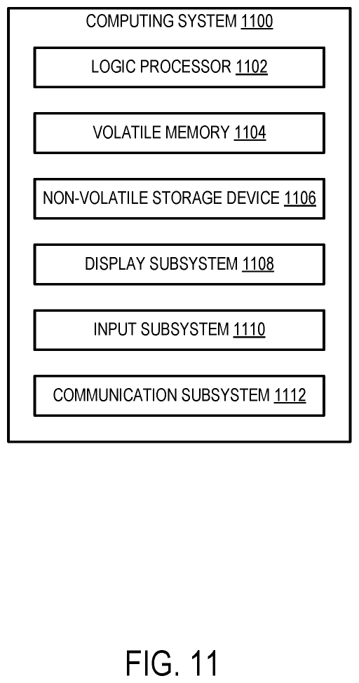

FIG. 11 schematically shows a non-limiting implementation of a computing system 1100 that can enact one or more of the methods and processes described above. Computing system 1100 is shown in simplified form. Computing system 1100 may embody the OCR customization computing system 100 and the application-specific computing systems 126A, 126B, 126C described above and illustrated in FIG. 2. Computing system 1100 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches, backpack host computers, and head-mounted augmented/mixed virtual reality devices.

Computing system 1100 includes a logic processor 1102, volatile memory 1104, and a non-volatile storage device 1106. Computing system 1100 may optionally include a display sub system 1108, input sub system 1110, communication subsystem 1112, and/or other components not shown in FIG. 11.

Logic processor 1102 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 1102 may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1102 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1106 includes one or more physical devices configured to hold instructions executable by the logic processors to implement the methods and processes described herein. When such methods and processes are implemented, the state of non-volatile storage device 1106 may be transformed—e.g., to hold different data.

Non-volatile storage device 1106 may include physical devices that are removable and/or built-in. Non-volatile storage device 1106 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1106 may include nonvolatile, dynamic, static, read/write, read-only, sequential-access, location-addressable, file-addressable, and/or content-addressable devices. It will be appreciated that non-volatile storage device 1106 is configured to hold instructions even when power is cut to the non-volatile storage device 1106.

Volatile memory 1104 may include physical devices that include random access memory. Volatile memory 1104 is typically utilized by logic processor 1102 to temporarily store information during processing of software instructions. It will be appreciated that volatile memory 1104 typically does not continue to store instructions when power is cut to the volatile memory 1104.

Aspects of logic processor 1102, volatile memory 1104, and non-volatile storage device 1106 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “module” may be used to describe an aspect of computing system 1100 typically implemented by a processor to perform a particular function using portions of volatile memory, which function involves transformative processing that specially configures the processor to perform the function. Thus, a module may be instantiated via logic processor 1102 executing instructions held by non-volatile storage device 1106, using portions of volatile memory 1104. It will be understood that different modules may be instantiated from the same application, service, code block, object, library, routine, API, function, pipeline, etc. Likewise, the same module, program, and/or engine may be instantiated by different applications, services, code blocks, objects, routines, APIs, functions, etc. The term “module” may encompass individual or groups of executable files, data files, libraries, drivers, scripts, database records, etc.

Any of the OCR systems and corresponding customization described above may be implemented using any suitable combination of state-of-the-art and/or future machine learning (ML), artificial intelligence (AI), and/or other natural language processing (NLP) techniques. Non-limiting examples of techniques that may be incorporated in an implementation of one or more machines include support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

Language models may utilize vocabulary features to guide sampling/searching for words for recognition of speech. For example, a language model may be at least partially defined by a statistical distribution of words or other vocabulary features. For example, a language model may be defined by a statistical distribution of n-grams, defining transition probabilities between candidate words according to vocabulary statistics. The language model may be further based on any other appropriate statistical features, and/or results of processing the statistical features with one or more machine learning and/or statistical algorithms (e.g., confidence values resulting from such processing). In some examples, a statistical model may constrain what words may be recognized for an audio signal, e.g., based on an assumption that words in the audio signal come from a particular vocabulary.

Alternately or additionally, the language model may be based on one or more neural networks previously trained to represent audio inputs and words in a shared latent space, e.g., a vector space learned by one or more audio and/or word models (e.g., wav2letter and/or word2vec). Accordingly, finding a candidate word may include searching the shared latent space based on a vector encoded by the audio model for an audio input, in order to find a candidate word vector for decoding with the word model. The shared latent space may be utilized to assess, for one or more candidate words, a confidence that the candidate word is featured in the speech audio.

In some examples, in addition to statistical models and neural networks, the language model may incorporate any suitable graphical model, e.g., a hidden Markov model (HMM) or a conditional random field (CRF). The graphical model may utilize statistical features (e.g., transition probabilities) and/or confidence values to determine a probability of recognizing a word, given the speech audio and/or other words recognized so far. Accordingly, the graphical model may utilize the statistical features, previously trained machine learning models, to define transition probabilities between states represented in the graphical model.

When included, display subsystem 1108 may be used to present a visual representation of data held by non-volatile storage device 1106. The visual representation may take the form of a graphical user interface (GUI). As the herein described methods and processes change the data held by the non-volatile storage device, and thus transform the state of the non-volatile storage device, the state of display subsystem 1108 may likewise be transformed to visually represent changes in the underlying data. Display subsystem 1108 may include one or more display devices utilizing virtually any type of technology. Such display devices may be combined with logic processor 1102, volatile memory 1104, and/or non-volatile storage device 1106 in a shared enclosure, or such display devices may be peripheral display devices.

When included, input subsystem 1110 may comprise or interface with one or more user-input devices such as a keyboard, mouse, touch screen, microphone for speech and/or voice recognition, a camera (e.g., a webcam), or game controller.

When included, communication subsystem 1112 may be configured to communicatively couple various computing devices described herein with each other, and with other devices. Communication subsystem 1112 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some implementations, the communication subsystem may allow computing system 1100 to send and/or receive messages to and/or from other devices via a network such as the Internet.

In an example, a method for customizing an optical character recognition system configured to convert a digital image into text, the optical character recognition system including a general-purpose decoder configured to convert character images, recognized in the digital image, into text based on a general-purpose text structure, the method comprises receiving an application-specific customization including an application-specific text structure that differs from the general-purpose text structure, generating a customized model based on the application-specific customization, and generating an enhanced application-specific decoder by modifying the general-purpose decoder to, during run-time execution of the optical character recognition system, leverage the customized model to convert character images demonstrating the application-specific text structure into text. In this example and/or another example, the application-specific text structure may include a customized vocabulary. In this example and/or another example, the application-specific text structure may include a designated format for an expression. In this example and/or another example, the designated format may specify a plurality of character positions of the expression, and one or more character positions of the plurality of character positions includes a number or a non-letter character. In this example and/or another example, the designated format may specify that the structured text includes specified columns and/or rows in a table. In this example and/or another example, the designated format may specify that the structured text is located in a designated region of the digital image. In this example and/or another example, the customized model may be weighted relative to a corresponding default model of the general-purpose decoder to bias the enhanced application-specific decoder to use the customized model instead of the default model to convert character images demonstrating the application-specific text structure into text. In this example and/or another example, the general-purpose decoder includes one or more default weighted finite state transducers (WFSTs) configured based on the general-purpose text structure, the general-purpose decoder may be modified by adding a customized non-terminal symbol to the one or more default WFSTs to generate the enhanced application-specific decoder, the customized non-terminal symbol may be configured to act as an entry and return point for a customized WFST that embodies the customized model, and the optical character recognition system may be configured to, during runtime execution, on-demand replace, the customized non-terminal symbol with the customized WFST, and the customized WFST may be configured to convert character images demonstrating the application-specific text structure into text. In this example and/or another example, the customized non-terminal symbol may include a unigram. In this example and/or another example, the customized non-terminal symbol may include a sentence. In this example and/or another example, the one or more default WFSTs may include a grammar WFST, a lexicon WFST, and a blank and repetition removal WFST. In this example and/or another example, the general-purpose decoder may include a neural network.

In another example, a method for customizing an optical character recognition system configured to convert a digital image into text, the optical character recognition system including a general-purpose decoder configured to convert character images, recognized in the digital image, into text based on a general-purpose text structure, the method comprises receiving an application-specific customization including an application-specific text structure that differs from the general-purpose text structure, generating a customized weighted finite state transducer (WFST) based on the application-specific customization, and generating an enhanced application-specific decoder by modifying the general-purpose decoder to include a customized non-terminal symbol that is configured to act as an entry and return point for the customized WFST, wherein the optical character recognition system is configured to use the enhanced application-specific decoder to convert character images recognized in the digital image into text, wherein the enhanced application-specific decoder is configured to, during runtime execution, on-demand replace, the customized non-terminal symbol with the customized WFST. In this example and/or another example, the application-specific text structure may include a customized vocabulary. In this example and/or another example, the application-specific text structure may include a designated format for an expression. In this example and/or another example, the designated format may specify a plurality of character positions of the expression, and one or more character positions of the plurality of character positions includes a number or a non-letter character. In this example and/or another example, the designated format may specify that the structured text includes specified columns and/or rows in a table. In this example and/or another example, the designated format may specify that the structured text is located in a designated region of the digital image. In this example and/or another example, the customized WFST may be weighted relative to a corresponding default WFST of the general-purpose decoder to bias the enhanced application-specific decoder to use the customized WFST instead of the default WFST to convert character images demonstrating the application-specific text structure into text.

In yet another example, a computing system comprises a logic processor, and a storage device holding instructions executable by the logic processor to receive an application-specific customization for an optical character recognition system configured to convert a digital image into text, the optical character recognition system including a general-purpose decoder configured to convert character images recognized in the digital image into text based on a general-purpose text structure, the application-specific customization including an application-specific text structure that differs from a general-purpose text structure, generate a customized model based on the application-specific customization, and generate an enhanced application-specific decoder by modifying the general-purpose decoder to, during run-time execution of the optical character recognition system, leverage the customized model to convert character images demonstrating the application-specific text structure into text.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for customizing an optical character recognition system configured to convert a digital image into text, the optical character recognition system including a general-purpose decoder configured to convert character images, recognized in the digital image, into text based on a general-purpose text structure, the method comprising:
receiving an application-specific customization including an application-specific text structure that differs from the general-purpose text structure;
generating a customized model based on the application-specific customization; and
generating an enhanced application-specific decoder by modifying the general-purpose decoder to, during run-time execution of the optical character recognition system, leverage the customized model to convert character images demonstrating the application-specific text structure into text.

2. The method of claim 1, wherein the application-specific text structure includes a customized vocabulary.

3. The method of claim 1, wherein the application-specific text structure includes a designated format for an expression.

4. The method of claim 3, wherein the designated format specifies a plurality of character positions of the expression, and one or more character positions of the plurality of character positions includes a number or a non-letter character.

5. The method of claim 3, wherein the designated format specifies that the structured text includes specified columns and/or rows in a table.

6. The method of claim 3, wherein the designated format specifies that the structured text is located in a designated region of the digital image.

7. The method of claim 1, wherein the customized model is weighted relative to a corresponding default model of the general-purpose decoder to bias the enhanced application-specific decoder to use the customized model instead of the default model to convert character images demonstrating the application-specific text structure into text.

8. The method of claim 1, wherein the general-purpose decoder includes one or more default weighted finite state transducers (WFSTs) configured based on the general-purpose text structure, wherein the general-purpose decoder is modified by adding a customized non-terminal symbol to the one or more default WFSTs to generate the enhanced application-specific decoder, the customized non-terminal symbol configured to act as an entry and return point for a customized WFST that embodies the customized model, and wherein the optical character recognition system is configured to, during runtime execution, on-demand replace, the customized non-terminal symbol with the customized WFST, and wherein the customized WFST is configured to convert character images demonstrating the application-specific text structure into text.

9. The method of claim 8, wherein the customized non-terminal symbol includes a unigram.

10. The method of claim 8, wherein the customized non-terminal symbol includes a sentence.

11. The method of claim 8, wherein the one or more default WFSTs includes a grammar WFST, a lexicon WFST, and a blank and repetition removal WFST.

12. The method of claim 1, wherein the general-purpose decoder includes a neural network.

13. A method for customizing an optical character recognition system configured to convert a digital image into text, the optical character recognition system including a general-purpose decoder configured to convert character images, recognized in the digital image, into text based on a general-purpose text structure, the method comprising:
receiving an application-specific customization including an application-specific text structure that differs from the general-purpose text structure;
generating a customized weighted finite state transducer (WFST) based on the application-specific customization; and
generating an enhanced application-specific decoder by modifying the general-purpose decoder to include a customized non-terminal symbol that is configured to act as an entry and return point for the customized WFST, wherein the optical character recognition system is configured to use the enhanced application-specific decoder to convert character images recognized in the digital image into text, wherein the enhanced application-specific decoder is configured to, during runtime execution, on-demand replace, the customized non-terminal symbol with the customized WFST.

14. The method of claim 13, wherein the application-specific text structure includes a customized vocabulary.

15. The method of claim 13, wherein the application-specific text structure includes a designated format for an expression.

16. The method of claim 15, wherein the designated format specifies a plurality of character positions of the expression, and one or more character positions of the plurality of character positions includes a number or a non-letter character.

17. The method of claim 15, wherein the designated format specifies that the structured text includes specified columns and/or rows in a table.

18. The method of claim 15, wherein the designated format specifies that the structured text is located in a designated region of the digital image.

19. The method of claim 13, wherein the customized WFST is weighted relative to a corresponding default WFST of the general-purpose decoder to bias the enhanced application-specific decoder to use the customized WFST instead of the default WFST to convert character images demonstrating the application-specific text structure into text.

20. A computing system comprising:
a logic processor; and
a storage device holding instructions executable by the logic processor to:
receive an application-specific customization for an optical character recognition system configured to convert a digital image into text, the optical character recognition system including a general-purpose decoder configured to convert character images recognized in the digital image into text based on a general-purpose text structure, the application-specific customization including an application-specific text structure that differs from a general-purpose text structure;
generate a customized model based on the application-specific customization; and
generate an enhanced application-specific decoder by modifying the general-purpose decoder to, during run-time execution of the optical character recognition system, leverage the customized model to convert character images demonstrating the application-specific text structure into text.
